(19) United States
(12) Patent Application Publication
(10) Pub. No.: US 2018/0012122 A1
(43) Pub. Date: Jan. 11, 2018

(54) ENHANCING WORKFLOW PERFORMANCE WITH COGNITIVE COMPUTING

(71) Applicant: HALLIBURTON ENERGY SERVICES, INC., Houston, TX (US)

(72) Inventors: Robert Lynn WILLIAMS, Spring, TX (US); Dale E. JAMISON, Humble, TX (US); Amir BAR, Houston, TX (US)

(73) Assignee: HALLIBURTON ENERGY SERVICES, INC., Houston, TX (US)

(21) Appl. No.: 15/544,593

(22) PCT Filed: Mar. 22, 2014
(86) PCT No.: PCT/US2015/021911

§ 371 Date: Jul. 19, 2017

(51) Int. Cl. G06N 3/04; G06Q 10/06; G06N 3/08; G06Q 50/02; G06N 3/063

(52) U.S. Cl. CPC G06N 3/0472; G06Q 50/02; G06N 3/063; G06N 3/08; G06Q 10/0633

(57) ABSTRACT

A cognitive computing system for enhancing workflow performance in the oil and gas industry, in some embodiments, comprises: neurosynaptic processing logic including multiple electronic neurons operating in parallel; input and output interfaces coupled to the neurosynaptic processing logic; and one or more information repositories accessible to the neurosynaptic processing logic, wherein the neurosynaptic processing logic receives a workflow enhancement request via the input interface, accesses the one or more information repositories to obtain information pertaining to the request, uses said information to perform a probability analysis, produces an option relating to the workflow enhancement request based on said probability analysis, and presents said option via the output interface.

### BACKGROUND

Computer scientists and engineers have long tried to create computers that mimic the mammalian brain. Such efforts have met with limited success. While the brain contains a vast, complex and efficient network of neurons that operate in parallel and communicate with each other via dendrites, axons and synapses, virtually all computers to date employ the traditional von Neumann architecture and thus contain some variation of a basic set of components (e.g., a central processing unit, registers, a memory to store data and instructions, external mass storage, and input/output devices). Due at least in part to this relatively simple architecture, von Neumann computers are adept at performing calculations and following specific, deterministic instructions, but—in contrast to the biological brain—they are generally inefficient; they adapt poorly to new, unfamiliar and probabilistic situations; and they are unable to learn, think, and handle data that is vague, noisy, or otherwise imprecise. These shortcomings substantially limit the traditional von Neumann computer's ability to make meaningful contributions in the oil and gas industry.

### BRIEF DESCRIPTION OF THE DRAWINGS

Accordingly, there are disclosed in the drawings and in the following description cognitive computing systems and methods that enhance workflow performance in the oil and gas industry. In the drawings:

FIG. 1A is an illustration of a pair of biological neurons communicating via a synapse.

FIG. 1B is a mathematical representation of an electronic neuron.

FIG. 1C is a schematic diagram of a neurosynaptic tile for use in a cognitive computer.

FIG. 1D is a schematic diagram of a circuit that embodies an electronic synapse.

FIG. 1E is a schematic diagram of an electronic neuron.

FIG. 1F is a block diagram of an electronic neuron spiking logic.

FIG. 2 is a schematic diagram of a neurosynaptic core for use in a cognitive computer.

FIG. 3 is a schematic diagram of a multi-core neurosynaptic chip for use in a cognitive computer.

FIG. 4 is a detailed schematic diagram of a dual-core neurosynaptic chip for use in a cognitive computer.

FIGS. 5 and 6 are conceptual diagrams of scalable corelets used for programming neurosynaptic processing logic.

FIG. 7 is a block diagram of a cognitive computing system that has access to multiple information repositories.

FIG. 8 is a flow diagram of a method used to enhance workflow performance using cognitive computers.

It should be understood, however, that the specific embodiments given in the drawings and detailed description thereto do not limit the disclosure. On the contrary, they provide the foundation for one of ordinary skill to discern the alternative forms, equivalents, and modifications that are encompassed together with one or more of the given embodiments in the scope of the appended claims.

### DETAILED DESCRIPTION

Disclosed herein are methods and systems for enhancing workflow performance in the oil and gas industry using cognitive computers. Cognitive computers—also known by numerous similar terms, including artificial neural networks, neuromorphic and synaptronic systems, and, in this disclosure, neurosynaptic systems—are modeled after the mammalian brain. In contrast to traditional von Neumann architectures, neurosynaptic systems include extensive networks of electronic neurons and cores operating in parallel with each other. These electronic neurons function in a manner similar to that in which biological neurons function, and they couple to electronic dendrites, axons and synapses that function like biological dendrites, axons and synapses. By modeling processing logic after the biological brain in this manner, cognitive computers—unlike von Neumann machines—are able to support complex cognitive algorithms that replicate the numerous advantages of the biological brain, such as adaptability to ambiguous, unpredictable and constantly changing situations and settings; the ability to understand context (e.g., meaning, time, location, tasks, goals); and the ability to learn new concepts.

Key among these advantages is the ability to learn, because learning fundamentally drives the cognitive computer's behavior. In the cognitive computer—just as with biological neural networks—learning (e.g., Hebbian learning) occurs due to changes in the electronic neuron and synapses as a result of prior experiences (e.g., a training session with a human user) or new information. These changes, described below, affect the cognitive computer's future behavior. In a simple example, a cognitive computer robot with no prior experience or software instructions with respect to coffee preparation can be introduced to a kitchen, shown what a bag of ground coffee beans looks like, and shown how to use a coffee machine. After the robot is trained, it will be able to locate materials and make the cup of coffee on its own, without human assistance. Alternatively, the cognitive computer robot may simply be asked to make a cup of coffee without being trained to do so. The computer may access information repositories via a network connection (e.g., the Internet) and learn what a cup is, what ground coffee beans are, what they look like and where they are typically found, and how to use a coffee machine—for example, by means of a YOUTUBE® video. A cognitive computer robot that has learned to make coffee in other settings in the past may engage in a conversation with the user to ask a series of specific questions, such as to inquire about the locations of a mug, ground coffee beans, water, the coffee machine, and whether the user likes sugar and cream with his coffee. If, while preparing the coffee, a wet coffee mug slips from the robot's hand and falls to the floor, the robot may infer that a wet mug is susceptible to slipping and it may grasp a wet mug a different way the next time it brews a cup of coffee.

The marriage between neurosynaptic architecture and cognitive algorithms represents the next step beyond artificial intelligence and can prove especially useful in the oil and gas industry. This disclosure describes the use of neurosynaptic technology (and associated cognitive algorithms) to intelligently assist in the performance of workflows by oil and gas industry personnel. In particular, when a cognitive computer is presented with a situation and a problem or query regarding that situation, it intelligently searches numerous information repositories for relevant data. It uses probabilistic algorithms to find the best options to address the problem based on the relevant data and generates arguments supporting and opposing the use of each of the options—all with minimal or no human assistance.

For example, details about a particular drill site may be provided to the cognitive computer and the computer may be asked about some aspect of drilling operations at the site. To answer the user's problem or query, the cognitive computer may access any and all information repositories available to it (e.g., any database or website accessible via a network). Based on the information provided by the user, the cognitive computer leverages a probabilistic algorithm to determine which repositories are most likely to contain the most relevant information, and it searches those repositories first. (If a particular repository has previously proven to be particularly valuable for the type of query at hand, the cognitive computer may have automatically learned to search that repository first.) Based on the information found, the computer may engage in a conversation with the user to identify additional, helpful information that can aid the computer in its efforts, and the computer may resume searching the repositories based on the additional information provided.

After intelligently searching the repositories and identifying a set of options that can be presented to the user, the cognitive computer ranks the options based on a ranking algorithm. The ranking algorithm may have been programmed directly into the computer, or the computer may have been trained to use the algorithm, or some combination thereof. The cognitive computer may have automatically modified its ranking algorithm based on past user option selections and subsequent outcomes so that the option most likely to be selected by the user is ranked highest and is most likely to produce the best outcome for the user. Based on all such information and any other relevant information obtained from the information repositories, the cognitive computer—without human assistance—produces arguments presenting the advantages and disadvantages associated with each option presented. These arguments are produced using the cognitive, probabilistic algorithms with which the cognitive computer is programmed or trained and using information the computer has learned in the past (e.g., facts obtained from information repositories or prior experiences).

The user and cognitive computer may engage in a discussion about the available options. The computer may answer the user's questions, and, in some embodiments, the computer may ask the user its own questions to further refine the list of possible options and rankings. For instance, when planning the location of a new well in an established field, the user may challenge the cognitive computer's recommendation by explaining that another well in that field has historically underperformed. The cognitive computer may rebut the user's argument with facts gleaned from any available information repository, having been trained to engage in such fact-based conversations in the past. The computer may, for example, explain that although the other well in the field has historically underperformed, the formation abutting that well was sub-optimally fractured. Based on the user's responses, the cognitive computer may learn for future use the types of facts and arguments the user finds most persuasive. When the user finally selects an option, the cognitive computer observes the consequences of that selection and modifies any accessible information repositories to reflect those consequences, thereby improving the accuracy and reliability of the data in the repositories. The foregoing description is merely illustrative of one non-limiting, potential application of cognitive computing in the oil and gas workflow context.

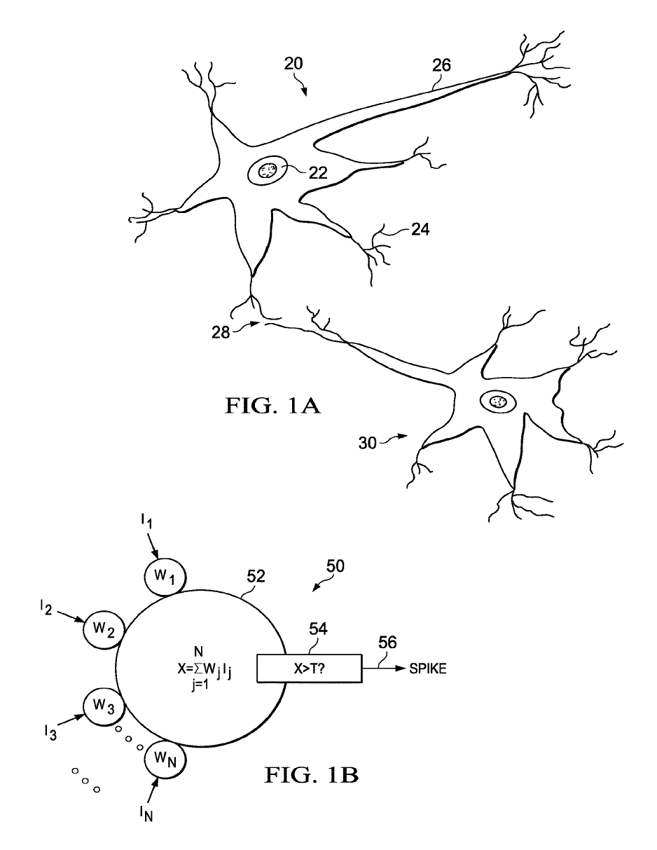

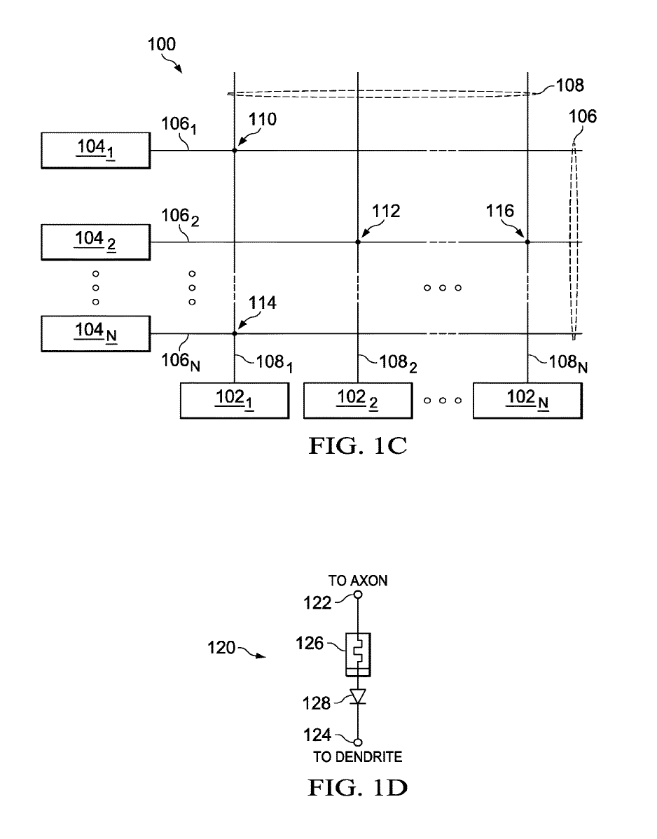

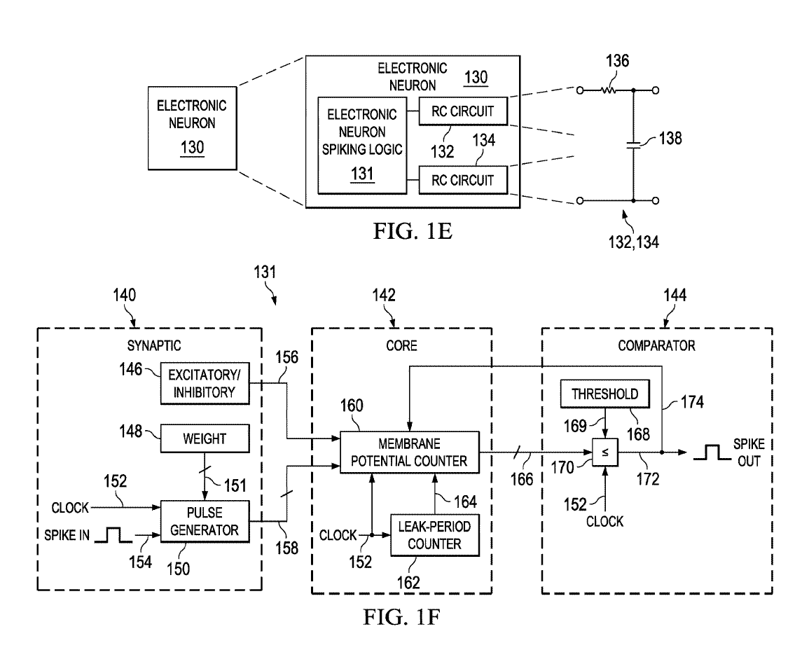

FIG. 1A is an illustration of a pair of biological neurons communicating via a synapse. Specifically, neuron 20 includes a nucleus 22, dendrites 24, an axon 26 and a synapse 28 by which it communicates with another neuron 30. The dendrites 24 serves as inputs to the neuron 20, while the axon 26 serves as an output from the neuron 20. The synapse 28 is the space between an axon of neuron 30 and a dendrite 24 of neuron 20, and it enables the neuron 30 to output information to the neuron 20 using neurotransmitters (e.g., dopamine, norepinephrine). The neuron 20 receives input from numerous neurons (not specifically shown) in addition to the neuron 30. Each of these inputs impacts the neuron 20 in different ways. Some of these neurons provide excitatory signals to the neuron 20, while other neurons provide inhibitory signals to the neuron 20. Excitatory signals push the membrane potential (i.e., the voltage difference between the neuron and the space surrounding the neuron, typically about −70 mV) toward a threshold value which, if exceeded, results in an action potential (or “spiking,” which is the transmission of a pulse) of the neuron 20, and inhibitory signals pull the membrane potential of the neuron 20 away from this threshold. The repeated excitation or inhibition the neuron 20 through these different input pathways results in learning. Stated another way, if a particular input to a neuron repeatedly and persistently causes that neuron to fire, a metabolic change occurs in the synapse associated with that input axon to reduce the resistance in the synapse. This phenomenon is known as the Hebbian learning rule. In a more specific version of Hebbian learning, called spike-timing-dependent plasticity (STDP), repeated presynaptic spike arrival a few milliseconds before postsynaptic action potentials leads to long-term potentiation of that synapse, whereas repeated presynaptic spike arrival a few milliseconds after postsynaptic action potentials leads to long-term depression of the same synapse. STDP is thus a form of neuroplasticity, in which synaptic changes occur due to changes in behavior, environment, neural processes, thinking, and emotions.

FIG. 1B is a mathematical representation of an electronic neuron 50 that mimics the behavior of a biological neuron. Specifically, the electronic neuron 50 includes a nucleus 52 that has multiple inputs I₁, I₂, . . . , I_{N}, and these inputs are associated with weights W₁, W₂ . . . . , W_{N}, respectively. The weight associated with an input dictates the impact that that input will have upon the neuron 50 and, more specifically, on the electronic neuron's mathematical equivalent of a biological membrane potential (which, for purposes of this discussion, will still be referred to as a membrane potential). The summation of the weighted inputs produces a membrane potential x, which causes a spike 56 if the potential x exceeds a threshold value T (numeral 54). Similar to Hebbian learning, repeated and persistent signals from a particular input to the electronic neuron 50 that causes the neuron to spike results in a shift in the magnitudes of weights W₁, W₂, . . . , W_{N} to increase the weight associated with that particular input.

FIG. 1C is a schematic diagram of a neurosynaptic tile 100 for use in a cognitive computer. The neurosynaptic tile 100 includes a plurality of electronic neurons 102₁, 102₂, . . . , 102_{N}. The tile 100 further includes a plurality of electronic neurons 104₁, 104₂, . . . , 104_{N}. Each of the neurons 104₁, 104₂, . . . , 104_{N} couples to an axon 106₁, 106₂, . . . , 106_{N} (generally indicated by numeral 106), respectively. Similarly, each of the neurons 102₁, 102₂, . . . , 102_{N} couples to a dendrite 108₁, 108₂, . . . , 108_{N} (generally indicated by numeral 108), respectively. The axons 106 and dendrites 108 couple to each other in predetermined locations. For example, axon 106₁ couples to dendrite 108₁ at an electronic synapse 110; axon 106₂ couples to dendrites 108₂, 108_{N} at synapses 112, 116, respectively; and axon 106_{N} couples to dendrite 108₁ at synapse 114. In operation, when any of the membrane potentials of the electronic neurons 104₁, 104₂, . . . , 104_{N} reaches or exceeds a threshold value, that neuron(s) fires on the corresponding axon(s) 106. The dendrites 108 to which the firing axons 106 couple receive the spikes and provide them to the neurons 102₁, 102₂, . . . , 102_{N}.

As explained above with respect to FIG. 1B, an electronic neuron may ascribe different weights to each input provided to that neuron. The same is true for the electronic neurons 102₁, 102₂, . . . , 102_{N} and 104₁, 104₂, . . . , 104_{N}. Thus, for example, the dendrite 108₁, which corresponds to electronic neuron 102₁, couples to axons 106₁, 106_{N} at synapses 110, 114, respectively, and the electronic neuron 102₁ ascribes different weights to the inputs from dendrites 106₁ and 106_{N}. If a greater weight is ascribed to dendrite 106₁, the excitatory or inhibitory signal provided by that dendrite receives greater consideration toward the calculation of the membrane potential of the neuron 102₁. Similarly, if a greater weight is ascribed to dendrite 106_{N}, the excitatory or inhibitory signal provided by that dendrite receives greater consideration toward the calculation of the membrane potential of the neuron 102₁. If the summation of the weighted signals received from the dendrites 106₁ and 106_{N} exceeds the threshold of the neuron 102₁, the neuron 102₁ spikes on its axon (not specifically shown). In this way—by strengthening some electronic synapses and weakening others through the adjustment of input weights—these neurons implement an electronic version of STDP.

FIG. 1D is a schematic diagram of a circuit that embodies an electronic synapse, such as the electronic synapses 110, 112, 114, 116 shown in FIG. 1C. Specifically, the electronic synapse 120 in FIG. 1D includes a node 122 that couples to an axon, a node 124 that couples to a dendrite, and a memristor 126 to store data. An optional access or control device 128 (e.g., a PN diode or field effect transistor (FET) wired as a diode, or some other element with a non-linear voltage-current response) may be coupled in series with the memristor 126 to prevent cross-talk during communication of neuronal spikes on adjacent axons or dendrites and to minimize leakage and power consumption. In some embodiments, a different memory element (e.g., static random access memory (SRAM), dynamic random access memory (DRAM), enhanced dynamic random access memory (EDRAM)) is used in lieu of the memristor 126.

FIG. 1E is a schematic diagram of an electronic neuron 130. Specifically, an electronic neuron 130 comprises electronic neuron spiking logic 131 and multiple resistor-capacitor (RC) circuits 132, 134. Although only two RC circuits are shown in the electronic neuron 130 of FIG. 1E, any suitable number of RC circuits may be used. Each RC circuit includes a resistor 136 and a capacitor 138 coupled as shown. When an electronic neuron fires (i.e., issues a spike) as a result of its membrane potential exceeding the neuron's firing threshold, the neuron maintains pre-synaptic and post-synaptic STDP variables. Each of these variables is a signal that decays with a relatively long time constant that is determined based on the values of the capacitor in a different one of the RCs 132, 134. Each of these signals may be sampled by determining the voltage across a corresponding RC circuit capacitor using, e.g., a current mirror. By sampling each of the variables, the length of time between the arrival of a pre-synaptic spike and a post-synaptic action potential following the spike arrival can be determined, as can the length of time between a post-synaptic action potential and a pre-synaptic spike arrival following the action potential. As explained above, the lengths of these times are used in STDP—that is, to effect synaptic potentiation and depression by adjusting synaptic weights, and thus to facilitate neurosynaptic learning.

FIG. 1F is a block diagram of the electronic neuron spiking logic 131 of FIG. 1E. The logic 131 includes three conceptual components: a synaptic component 140, a neuronal core component 142, and a comparator component 144. Although FIG. 1F shows only one synaptic component 140, in practice, a separate synaptic component 140 is used for each synapse from which the electronic neuron receives input. Thus, in some embodiments the electronic neuron contains multiple synaptic components 140, one for each synapse from which that neuron receives input. In other embodiments, the synaptic component 140 forms a part of the synapse itself and not the electronic neuron. In either type of embodiment, the end result is the same.

Each synaptic component 140 includes an excitatory/inhibitory signal generator 146, a weight signal generator 148 associated with the corresponding synapse, and a pulse generator 150. The pulse generator 150 receives a clock signal 152 and a spike input signal 154, as well as a weight signal 151 from the weight signal generator 148. The pulse generator 150 uses its inputs to generate a weighted spike signal 158—for instance, the spike input signal 154 multiplied by the weight signal 151. The width of the weighted spike signal pulse reflects the magnitude of the weighted signal, and thus the magnitude that will contribute to or take away from the membrane potential of the electronic neuron. The weighted signal for the synapse corresponding to the synaptic component 140 is provided to the core component 142, and similar weighted signals are provided from synaptic components 140 corresponding to other synapses from which the electronic neuron receives input. For each weighted signal that the core 142 receives from a synaptic component 140, the core 142 also receives a signal 156 from the excitatory/inhibitory signal generator 146 indicating whether the weighted signal 158 is an excitatory (positive) or inhibitory (negative) signal. An excitatory signal pushes the membrane potential of the electronic neuron toward its action potential threshold, while an inhibitory signal pulls the membrane potential away from the threshold. As explained, the neurosynaptic learning process involves the adjustment of synaptic weights. Such weights can be adjusted by modifying the weight signal generator 148.

The core component 142 includes a membrane potential counter 160 and a leak-period counter 162. The membrane potential counter receives the weighted signal 158 and the excitatory/inhibitory signal 156, as well as the clock 152 and a leak signal 164 from the leak-period counter 162. The leak-period counter 162, in turn, receives only clock 152 as an input. In operation, the membrane potential counter 160 maintains a counter—initially set to zero—that is incremented when excitatory, weighted signals 158 are received from the synaptic component 140 and that is decremented when inhibitory, weighted signals 158 are received from the synaptic component 140. When no synapse pulse is applied to the core component 142, the leak period counter signal 164 causes the membrane potential counter 160 to gradually decrement at a predetermined, suitable rate. This action mimics the leak experienced in biological neurons during a period in which no excitatory or inhibitory signals are received by the neuron. The membrane potential counter 160 outputs a membrane potential signal 166 that reflects the present value of the counter 160. This membrane potential signal 166 is provided to the comparator component 144.

The comparator component 144 includes a threshold signal generator 168 and a comparator 170. The threshold generator 168 generates a threshold signal 169, which reflects the threshold at which the electronic neuron 130 generates a spike signal. The comparator 170 receives this threshold signal 169, along with the membrane potential signal 166 and the clock 152. If the membrane potential signal 166 reflects a counter value that is equal to or greater than the threshold signal 169, the comparator 170 generates a spike signal 172, which is subsequently output via an axon of the electronic neuron. As numeral 174 indicates, the spike signal is also provided to the membrane potential counter 160, which, upon receiving the spike signal, resets itself to zero.

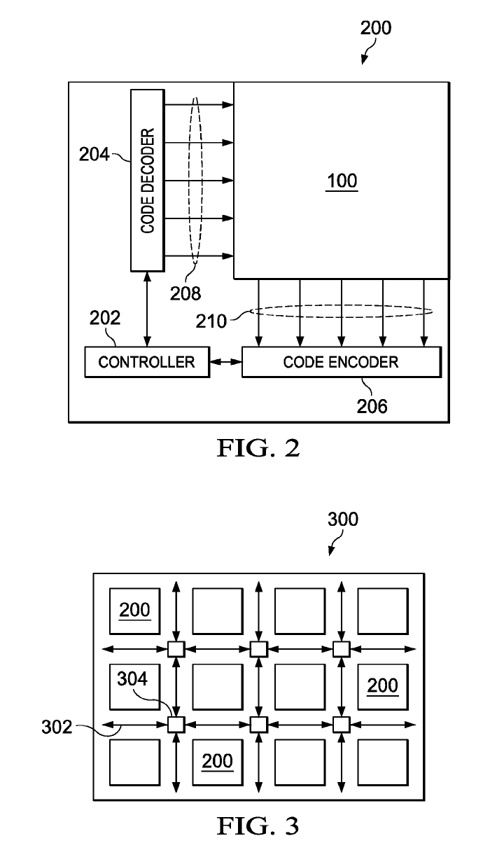

FIG. 2 is a schematic diagram of a neurosynaptic core 200 for use in a cognitive computer. The core 200 includes a neurosynaptic tile 100, a controller 202, a decoder 204, an encoder 206, inputs 208, and outputs 210. Spike events generated by electronic neurons generally take the form of data packets. These packets, which may be received from neurons on other cores external to the core 200, are decoded by the decoder 204 (e.g., to interpret and remove packet headers) and passed as inputs 208 to the neurosynaptic tile 100. Similarly, packets generated by neurons within the neurosynaptic tile 100 that are destined for neurons outside the core 200 are passed as outputs 210 to the encoder 206 for encoding (e.g., to include a header with a destination address). The controller 202 controls the decoder 204 and encoder 206.

FIG. 3 is a schematic diagram of a multi-core neurosynaptic chip 300 for use in a cognitive computer. The chip 300 includes a plurality of neurosynaptic cores 200, such as the core 200 described with respect to FIG. 2. The cores 200 couple to each other via electrical connections (e.g., conductive traces). The chip 300 may include any suitable number of cores—for example, 4,096 or more cores on a single chip, with each core containing millions of electronic synapses. The chip 300 also contains a plurality of intrachip spike routers 304 that couple to a routing fabric 302. The cores 200 communicate with each other via the routers 304 and the fabric 302, using the aforementioned encapsulated, encoded packets to facilitate routing between cores and specific neurons within the cores.

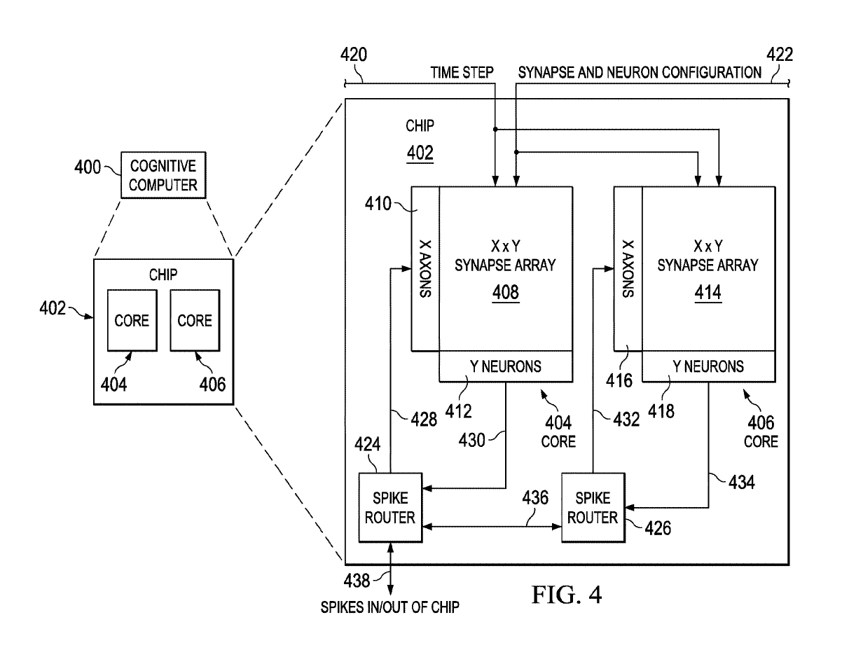

FIG. 4 is a detailed schematic diagram of a dual-core neurosynaptic chip 402 for use in a cognitive computer 400. Specifically, a cognitive computer may include any suitable number of neurosynaptic chips 402, and each of these neurosynaptic chips 402 may include any suitable number of neurosynaptic cores, as previously explained. In the example of FIG. 4, the neurosynaptic chip 402 is a dual-core chip containing neurosynaptic cores 404, 406. The core 404 includes a synapse array 408 that includes a plurality of synapses that couple various axons 410 to dendrites. In some embodiments, axons 410 receive spikes from neurons directly coupled to the axons 410 and included on the core 404 (not specifically shown in FIG. 4, but an illustrative embodiment is shown in FIG. 1). In other embodiments, axons 410 are extensions of neurons located off of the core 404 (e.g., elsewhere on the chip 402, or on a different chip). In embodiments where the axons 410 couple directly to on-core neurons (e.g., as shown in FIG. 1), the spike router 424 provides spikes directly to the neurons' dendrites. In embodiments where the axons 410 are extensions of off-core neurons, the spike router 424 provides spikes from those neurons to the axons 410. Although a multitude of variations of such embodiments are possible, for brevity, FIG. 4 shows only an array of axons 410.

The synapse array 408 also couples to neurons 412. The neurons 412 may be a single-row, multiple-column array of neurons, or, alternatively, the neurons 412 may be a multiple-row-, multiple-column array of neurons. In either case, dendrites of the neurons 412 couple to axons 410 in the synapse array 408, thus facilitating the transfer of spikes from the axons 410 to the neurons 412 via dendrites in the synapse array 408. The spike router 424 receives spikes from off-core sources, such as the core 406 or off-chip neurons. The spike router 424 uses spike packet headers to route the spikes to the appropriate neurons 412 (or, in some embodiments, on-core neurons directly coupled to axons 410). In either case, bus 428 provides data communication between the spike router 424 and the core 404. Similarly, neurons 412 output spikes on their axons and bus 430 provides the spikes to the spike router 424. The core 406 is similar or identical to the core 404. Specifically, the core 406 contains axons 416, neurons 418, and a synapse array 414. The axons 416 couple to a spike router 426 via bus 432, and neurons 418 couple to the spike router 426 via bus 434. The functionality of the core 406 is similar or identical to that of the core 404 and thus is not described. A bus 436 couples the spike routers 424, 426 to facilitate spike routing between the cores 404, 406. A bus 438 facilitates the communication of spikes on and off of the chip 402. The architectures shown in FIGS. 1-4 (e.g., the TRUENORTH® architecture by IBM®) are non-limiting; other architectural configurations are contemplated and included within the scope of the disclosure.

Various types of software may be written for use in cognitive computers. One programming methodology is described below, but the scope of disclosure is not limited to this particular methodology. Any suitable, known software architecture for programming neurosynaptic processing logic is contemplated and intended to fall within the scope of the disclosure. The software architecture described herein entails the creation and use of programs that are complete specifications of networks of neurosynaptic cores, along with their external inputs and outputs. As the number of cores grows, creating a program that completely specifies the network of electronic neurons, axons, dendrites, synapses, spike routers, buses, etc. becomes increasingly difficult. Accordingly, a modular approach may be used, in which a network of cores and/or neurons encapsulates multiple sub-networks of cores and/or neurons; each of the sub-networks encapsulates additional sub-networks of cores and/or neurons, and so forth. In some embodiments, the CORELET® programming language, library and development environment by IBM® may be used to develop such modular programs.

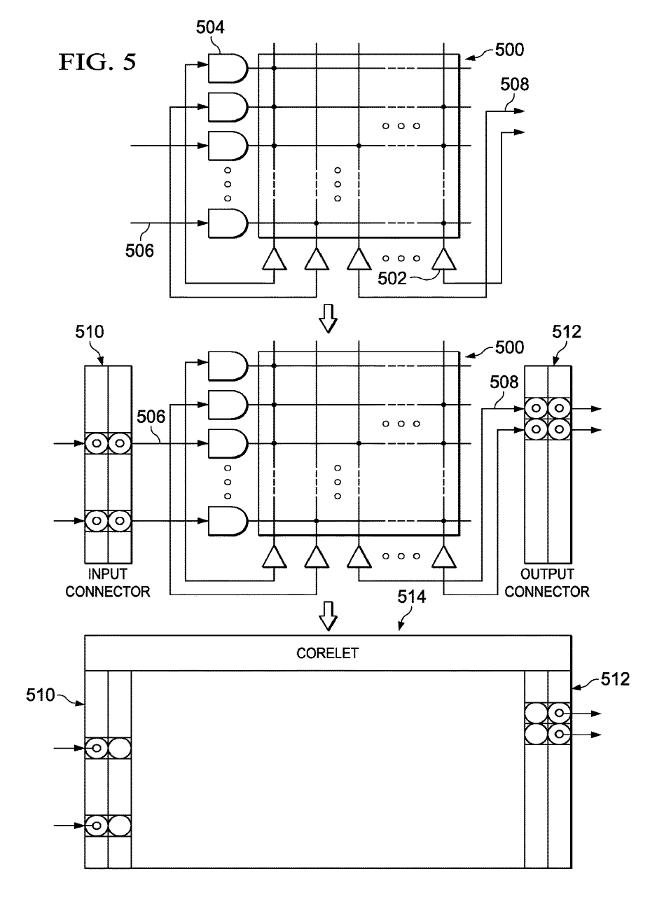

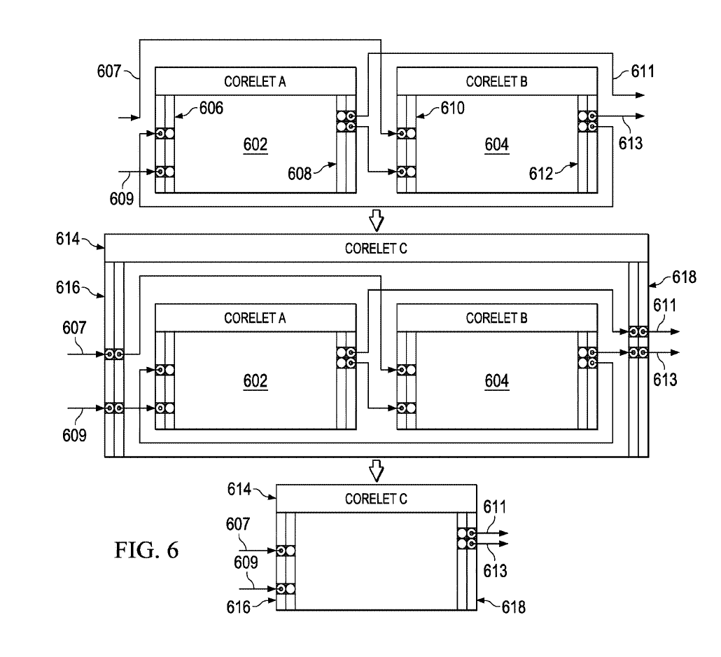

FIGS. 5 and 6 are conceptual diagrams illustrating the modular nature of the CORELET® programming architecture. FIG. 5 contains three panels. The first panel illustrates a neurosynaptic tile 500 containing a plurality of neurons 502 and axons 504, similar to the neurosynaptic architecture shown in FIG. 4. As shown, some of the neurons' outputs couple to the axons' inputs. However, inputs to other axons 504 are received from outside the tile 500, as numeral 506 indicates. Similarly, outputs from other neurons 502 are provided outside of the tile 500, as numeral 508 indicates. The second panel in FIG. 5 illustrates the initial step in the encapsulation of a tile into a corelet—that is, an abstraction that represents a program (for a neurosynaptic processing logic) that only exposes external inputs and outputs while encapsulating all other details into a “black box.” Thus, as shown in the second panel, the only inputs to the tile 500 are inputs 506 to some of the axons 504, and the only outputs from the tile 500 are outputs 508 from some of the neurons 502. The inputs 506 couple to an input connector 510, and the outputs couple to an output connector 512. The third panel in FIG. 5 shows the completed corelet 514, with only the input connector 510 and output connector 512 being exposed, and with the remainder of the tile 500 having been encapsulated into the corelet 514. The completed corelet 514 constitutes a single building block of the CORELET® modular architecture; the corelet 514 may be grouped with one or more other corelets to form a larger corelet; in turn, that larger corelet may be grouped with one or more other larger corelets to form an even larger corelet, and so forth.

FIG. 6 includes three panels illustrating such encapsulation of multiple sub-corelets into a larger corelet. Specifically, the first panel includes corelets 602 and 604. Corelet 602 includes an input connector 606 and output connector 608. The remainder of the contents of the corelet 602 do not couple to circuitry outside of the corelet 602 and thus are not specifically shown as being coupled to the input connector 606 or the output connector 608. Similarly, corelet 604 includes an input connector 610 and an output connector 612. Certain inputs to and outputs from the corelets 602, 604 couple to each other, while other such inputs and outputs do not (i.e., inputs 607, 609 are not received from either corelet 602, 604, and outputs 611, 613 are not provided to either corelet 602 or 604). Thus, as shown in the second and third panels of FIG. 6, when the corelets 602, 604 are grouped into a single, larger corelet 614, only inputs 607, 609 are exposed on the input connector 616, and only outputs 611, 613 are exposed on the output connector 618. The remaining contents of the corelet 614 are encapsulated. As explained, one purpose of encapsulating neurosynaptic processing logic into corelets and sub-corelets is to organize the processing logic in a modular way that facilitates the creation of CORELET® programs, since such programs are complete specifications of networks of neurosynaptic cores. Although FIGS. 5 and 6 demonstrate the modular nature of the CORELET® software architecture, the CORELET® syntax itself is known and is not described here. Cognitive computing software systems other than CORELET® also may be used in conjunction with the hardware described herein or with any other suitable cognitive computing hardware. All such variations and combinations of potentially applicable cognitive computing hardware and software are contemplated and may be used to implement the workflow enhancement techniques described herein.

The remainder of this disclosure describes the use of hardware and software cognitive computing technology to facilitate the performance of workflows by oil and gas industry personnel. As explained above, any suitable cognitive computing hardware or software technology may be used to implement such techniques. This cognitive computing technology may include none, some or all of the hardware and software architectures described above. For example, the workflow facilitation techniques described below may be implemented using the CORELET® programming language or any other software language used in conjunctive with cognitive computers. The foregoing architectural descriptions, however, are non-limiting. Other hardware and software architectures may be used in lieu of, or to complement, any of the foregoing technologies. Any and all such variations are included within the scope of the disclosure.

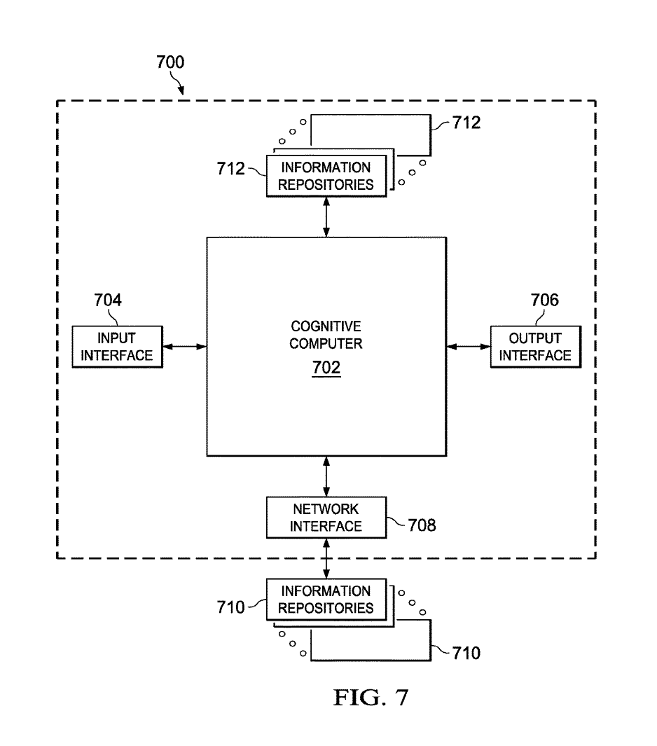

FIG. 7 is a block diagram of a cognitive computing system 700 that has access to multiple information repositories. Specifically, the cognitive computing system 700 includes a cognitive computer 702 (i.e., any suitable computer that includes neurosynaptic processing logic and cognitive algorithm-based software, such as those described above) coupled to an input interface 704, an output interface 706, a network interface 708 and one or more local information repositories 712. In at least some embodiments, the input interface 704 is any suitable input device(s), such as a keyboard, mouse, microphone, video camera, or one or more wearable devices (e.g., augmented reality device such as GOOGLE GLASS®. Other input devices are contemplated. The output interface 706 may include one or more of a display and an audio output device. Other output devices are contemplated. The network interface 708 is, for example, a network adapter or other suitable interface logic that enables communication between the cognitive computer 702 and any device not directly coupled to the cognitive computer 702. The local information repositories 712 include, without limitation, thumb drives, compact discs, Bluetooth devices, and any other device that can couple directly to the cognitive computer 702 such as by universal serial bus (USB) cable or high definition multimedia interface (HDMI) cable.

The cognitive computer 702 communicates with any number of information repositories 710 via the network interface 708. The quantity and types of such information repositories 710 may vary widely, and may include, without limitation, other cognitive computers; databases; distributed databases; sources that provide real-time data pertaining to oil and gas operations, such as drilling, fracturing, cementing, or seismic operations; servers; other personal computers; mobile phones and smart phones; websites and generally any resource(s) available via the Internet, World Wide Web, or a local network connection such as a virtual private network (VPN); cloud-based storage; libraries; and company-specific, proprietary, or confidential data. Any other suitable source of information with which the cognitive computer 702 can communicate is included within the scope of disclosure as a potential information repository 710. The cognitive computer 702—which, as described above, has the ability to learn, process imprecise or vague information, and adapt to unfamiliar environments—is able to receive a scenario and a query via the input interface 704 and intelligently determine a solution to the query based on the scenario and the information available in the information repositories 710, 712. The software stored on the cognitive computer 702 is probabilistic (i.e., non-deterministic) in nature, meaning that its behavior is guided by probabilistic determinations regarding the various possible outcomes of each action that can be taken in a given situation. In addition, in some embodiments, information is presented to the cognitive computer 702 and the cognitive computer 702 automatically assimilates the presented information. The presented information may include at least some of the information available on the information repositories 710, 712. In some embodiments, personnel may train the cognitive computer 702 to include this information.

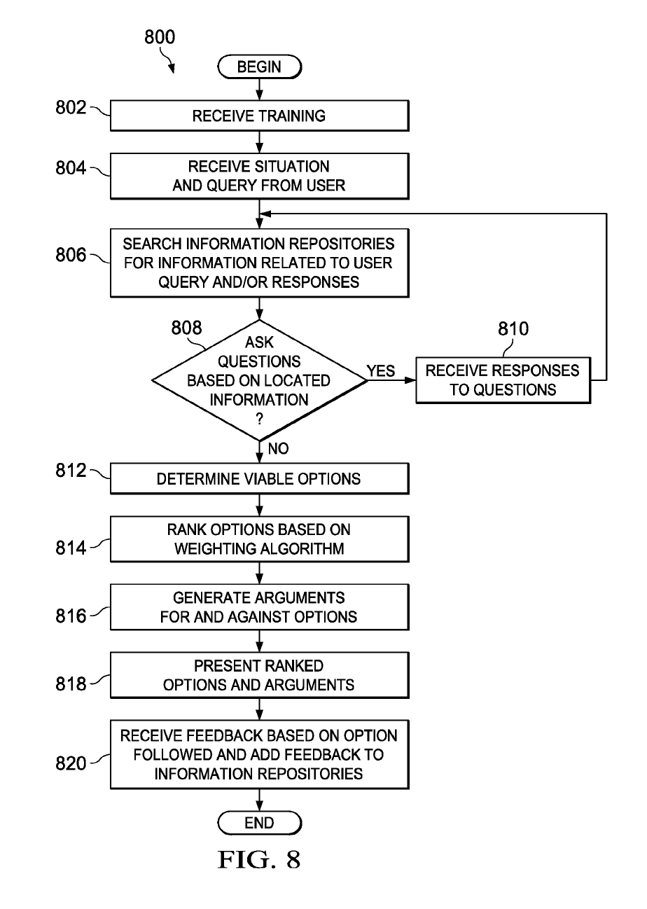

FIG. 8 is a flow diagram of a method 800 used to enhance workflow performance using cognitive computers, such as the cognitive computer shown in FIG. 7. Workflows are typically step-by-step processes that oil and gas personnel may perform to achieve a particular goal. For example, a workflow may be generated for drill rig personnel to ensure safety of all crew aboard the rig in the event that a safety alarm is activated. In that case, the personnel performing the set of steps to ensure safety of the crew—that is, performing the workflow—may encounter a step for which they need assistance. In that event, the personnel performing the steps of the workflow may turn to the cognitive computer for help. In other applications, the personnel may ask the cognitive computer to perform all of the steps of that workflow. Any number of workflow scenarios and applications may arise in the oil and gas industry context, and a cognitive computer implementing neurosynaptic processing logic (e.g., using IBM® TRUENORTH®) to execute cognitive algorithms (e.g., using IBM® CORELET®) may assist with some or all of the steps of such workflows.

The method 800 begins with a training phase (step 802) in which the cognitive computer is trained to perform a certain task—in this case, to evaluate a given situation in an oil and gas industry workflow and to determine the best course of action when confronted with a query regarding that situation. This is achieved is by providing the cognitive computer with sufficient information so that, over time, its electronic neurons apply the appropriate weights to their various synaptic inputs so as to produce the desired axonal outputs—that is, the cognitive computer learns. Such information that results in the proper calibration of synaptic weights may include, for example, repeatedly exposing the cognitive computer to desired courses of action and optimal behavioral patterns. In the current application, such training may include, for instance, repeatedly providing the cognitive computer with a mock workflow scenario, querying the computer for the best solution(s) to a given problem, and guiding the computer through the proper problem solving processes that it should follow to reach the solution. In general, the training phase of step 802 requires that a user “teach” the cognitive computer how it should behave when confronted with a problem such as the workflow facilitation problem described in FIG. 8.

After the cognitive computer has been properly trained, the method 800 includes the cognitive computer receiving information pertaining to the workflow situation and a specific query regarding the situation (step 804). Together, the workflow situation and specific query constitute a “workflow enhancement request.” The information pertaining to the workflow situation may include any and all relevant facts associated with the workflow, such as and without limitation, the steps of the workflow, the personnel involved, the resources available, time constraints, financial constraints, and so forth. In preferred embodiments, even seemingly irrelevant facts are provided to the cognitive computer, because a relationship between the seemingly irrelevant facts and the situation at hand may be apparent to a cognitive computer. The query provided to the cognitive computer may be of any nature, as the cognitive computer is capable of adapting to vague and imprecise instructions. In preferred embodiments, during step 804 the cognitive computer engages in a conversation with the personnel to obtain clarification regarding any of the information that has been provided. Personnel may provide information to and generally interact with the cognitive computer via any suitable input device, such as a microphone, a keyboard, a display, and/or a wearable device (e.g., an augmented reality device such as GOOGLE GLASS®).

The method 800 subsequently includes the cognitive computer searching information repositories and/or searching assimilated knowledge that the computer stores along with knowledge learned from prior experiences (collectively called a “knowledge corpus”) for information related to the query or to other information provided by personnel (as described below with respect to step 810) (step 806). Referring briefly to FIG. 7, the information repositories searched include both local information repositories 712 and network-accessible information repositories 710. Examples of both types of repositories are provided above and are not reproduced here.

Referring again to FIG. 8, upon accessing the information repositories the cognitive computer determines whether additional information from personnel would be helpful in formulating solutions to the query presented at step 804 (step 808). Typically, such additional information would resolve issues or problems that the cognitive computer discovers during its search of the information repositories. For instance, during its search of the information repositories or its own knowledge corpus, the cognitive computer may discover that the best solution to the query presented depends on a fiscal budgeting issue, and the information repositories have limited or no data pertaining to that issue. In such instances, the cognitive computer may request and receive additional information from personnel that presented the query (step 810) and may resume interacting with the information repositories based on the additional information received (step 806).

If the cognitive computer determines that it will not request additional information (step 808), the computer uses the information it has collected to determine viable options or solutions to the query presented (step 812). The manner in which this step is performed largely depends on the way the cognitive computer has been programmed and, to a greater extent, the way it has been trained. During the training phase (step 802), the cognitive computer will have learned how to sift through information from repositories, identify the most relevant information in those repositories, and use that information to determine appropriate options in response to the query presented. The cognitive computer determines the set of possible options at least in part using probabilistic algorithms with which the computer has been trained or programmed. Such probabilistic algorithms cause the cognitive computer to assess a given scenario and a set of relevant information and to determine what outcomes are most likely from a particular course of action. The probabilistic algorithm causes the cognitive computer to consider not just the immediate outcomes that may likely result from a particular course of action, but it also enables the computer to consider the most likely long-term, secondary and tertiary effects that a human user would not be able to foresee. The cognitive computer may store such options (along with any other relevant data) for future use, for example in the electronic synapses (FIGS. 1C, 1D) of a synaptic array (FIG. 4).

After it has determined a set of appropriate options, the cognitive computer ranks the options based on a weighting algorithm (step 814). The weighting algorithm dictates factors that are more important and those that are less important. The algorithm may have been directly programmed into the cognitive computer by a programmer, or the cognitive computer may learn the weighting algorithm during the training phase. Options that have a positive impact on the most important factors may be ranked more highly than options that have a positive impact on factors of lesser importance. Similarly, options that have a negative impact on the most important factors may be ranked lower than options that have a negative impact on factors of greater importance. The weighting algorithm is probabilistic in nature, so the rankings of the potential options takes into account the most likely and least likely outcomes if each option is or is not exercised (including tangential or long-term outcomes that may be difficult for personnel to foresee). This description of the weighting algorithm is merely illustrative. In practice, the particulars of the weighting algorithm(s) are programmed into the computer by a programmer, and a trainer subsequently trains the cognitive computer to use the weighting algorithms in the relevant oil and gas application(s). For example and without limitation, the trainer may train the cognitive computer to understand the relevant oil and gas application, desirable outcomes, undesirable outcomes, relevant constraints (e.g., technical, legal, financial constraints) and relevant goals, and the cognitive computer may adjust the weighting algorithm(s) accordingly. All suitable variations and permutations of such weighting algorithms are included in the scope of the disclosure.

The cognitive computer then generates—without human assistance—arguments for and against each of the options (step 816) and presents the options and arguments to personnel (step 818). Stated another way, these arguments are the “pros” and “cons” associated with each of the options. The cognitive computer will have been trained to use facts to generate and support each of its arguments. For example, in recommending that a well be drilled in a specific location, the computer may list facts supporting that particular location (e.g., calculations demonstrating proper spacing from other wells, production numbers evidencing rich production history in the area) and facts that oppose drilling in that particular location (e.g., budget spreadsheet analyses describing relevant financial considerations). The cognitive computer performs thorough, probabilistic analyses (including secondary and tertiary analyses) of all potential options in light of the relevant information it collects from the information repositories and uses these analyses in intelligently formulating its fact-based arguments. In some embodiments, the cognitive computer engages in a conversation—using any suitable input and output interfaces—with personnel to discuss the ranked list of options and the arguments associated with each of the options. For example, personnel may challenge the cognitive computer's arguments supporting a particular course of action and may demand that the computer explain the assumptions it used to formulate the arguments. In response, the computer may reveal its assumptions and facts supporting those assumptions. Similarly, personnel may pose a series of questions regarding the options or arguments or regarding the facts or assumptions supporting the options and arguments. The cognitive computer responds to each of these without human assistance and in accordance with its training and its probabilistic algorithms. The cognitive computer's actions and outputs are not, however, restricted solely to its programming and training. Instead, as described above, the cognitive computer learns as it performs. Thus, for instance, over time the computer may learn for itself what arguments the user finds most persuasive, weaknesses in its own reasoning, which information repositories contain reliable data and which do not, and so on.

Oil and gas personnel interacting with the cognitive computer will ultimately exercise an option presented by the computer. Alternatively, the cognitive computer may exercise an option on personnel's behalf. The outcomes of that option—as well as any other relevant information pertaining to the exercise of the option—may be provided to the cognitive computer so that the information may be stored on the computer or in a suitable information repository for future reference (step 820). In alternative embodiments, the cognitive computer automatically identifies the pertinent outcomes and stores them to the appropriate information repositories for future reference. The process is then complete. The method 800 may be modified in any suitable manner. Steps may be added, removed, rearranged or modified as may be suitable.

Numerous other variations and modifications will become apparent to those skilled in the art once the above disclosure is fully appreciated. It is intended that the following claims be interpreted to embrace all such variations, modifications and equivalents. In addition, the term “or” should be interpreted in an inclusive sense.

The present disclosure encompasses numerous embodiments. At least some of these embodiments are directed to a cognitive computing system for enhancing workflow performance in the oil and gas industry that comprises: neurosynaptic processing logic including multiple electronic neurons operating in parallel; input and output interfaces coupled to the neurosynaptic processing logic; and one or more information repositories accessible to the neurosynaptic processing logic, wherein the neurosynaptic processing logic receives a workflow enhancement request via the input interface, accesses the one or more information repositories to obtain information pertaining to the request, uses said information to perform a probability analysis, produces an option relating to the workflow enhancement request based on said probability analysis, and presents said option via the output interface. Such embodiments may be supplemented in a variety of ways, including by adding any of the following concepts, in any sequence and in any combination: wherein, without human assistance, the neurosynaptic processing logic generates an argument in favor of said option; wherein, without human assistance, the neurosynaptic processing logic generates an argument against said option; wherein, without human assistance, the neurosynaptic processing logic responds to a question about said option; wherein the neurosynaptic processing logic produces a second option relating to the workflow enhancement request, ranks the option and the second option, and presents the ranking via the output interface; wherein the neurosynaptic processing logic formulates a question relating to the request, and wherein the neurosynaptic processing logic presents said question via the output interface; wherein the neurosynaptic processing logic receives additional input in response to said question, and wherein the neurosynaptic processing logic accesses the one or more information repositories based on said additional input; wherein the neurosynaptic processing logic identifies a result that occurs when the option is exercised, and wherein the neurosynaptic processing logic provides said result to the one or more information repositories; wherein the system engages in a conversation with a user of the system regarding said option; wherein the system is implemented in the context of an oil and gas industry application.

At least some embodiments are directed to a cognitive computer for facilitating workflow completion in the oil and gas industry, comprising: a plurality of neurosynaptic cores operating in parallel, each neurosynaptic core coupled to at least one other neurosynaptic core and comprising multiple electronic neurons, electronic dendrites and electronic axons, at least some of said electronic dendrites and electronic axons coupling to each other in a synapse array; and a network interface coupled to at least one of the plurality of neurosynaptic cores, the network interface provides access to one or more information repositories, wherein the plurality of neurosynaptic cores accesses the one or more information repositories via the network interface to identify multiple solutions to a workflow enhancement request, determines a ranking of the multiple solutions, and presents the ranking to a user of the cognitive computer. Such embodiments may be supplemented in a variety of ways, including by adding any of the following concepts, in any sequence and in any combination: wherein the synapse array stores information pertaining to the multiple solutions; wherein the plurality of neurosynaptic cores generates arguments in support of and against each of said multiple solutions without human assistance; wherein the workflow enhancement request pertains to a workflow for oil and gas industry personnel.

At least some embodiments are directed to a method for enhancing workflow performance in the oil and gas industry, comprising: receiving, at a cognitive computer, an inquiry regarding a workflow; accessing information relating to the inquiry from an information repository using the cognitive computer; using the cognitive computer and said information to generate an option relating to the inquiry; and presenting said option to a user of the cognitive computer. Such embodiments may be supplemented in a variety of ways, including by adding any of the following concepts, in any sequence and in any combination: further comprising storing data pertaining to said option in an electronic synapse at an intersection of an axon and a dendrite associated with an electronic neuron in said cognitive computer; further comprising the cognitive computer generating an argument favoring said option; further comprising the cognitive computer generating an argument against said option; further comprising the cognitive computer identifying a need for additional information, requesting and receiving said additional information, and using the additional information to generate said option; further comprising providing the cognitive computer with said inquiry using an augmented reality device.

1. A cognitive computing system for enhancing workflow performance in the oil and gas industry, comprising:
neurosynaptic processing logic including multiple electronic neurons operating in parallel;
input and output interfaces coupled to the neurosynaptic processing logic; and
one or more information repositories accessible to the neurosynaptic processing logic,
wherein the neurosynaptic processing logic receives a workflow enhancement request via the input interface, accesses the one or more information repositories to obtain information pertaining to the request, uses said information to perform a probability analysis, produces an option relating to the workflow enhancement request based on said probability analysis, and presents said option via the output interface.

2. The cognitive computing system of claim 1, wherein, without human assistance, the neurosynaptic processing logic generates an argument in favor of said option.

3. The cognitive computing system of claim 1, wherein, without human assistance, the neurosynaptic processing logic generates an argument against said option.

4. The cognitive computing system of claim 1, wherein, without human assistance, the neurosynaptic processing logic responds to a question about said option.

5. The cognitive computing system of claim 1, wherein the neurosynaptic processing logic produces a second option relating to the workflow enhancement request, ranks the option and the second option, and presents the ranking via the output interface.

6. The cognitive computing system of claim 1, wherein the neurosynaptic processing logic formulates a question relating to the request, and wherein the neurosynaptic processing logic presents said question via the output interface.

7. The cognitive computing system of claim 6, wherein the neurosynaptic processing logic receives additional input in response to said question, and wherein the neurosynaptic processing logic accesses the one or more information repositories based on said additional input.

8. The cognitive computing system of claim 1, wherein the neurosynaptic processing logic identifies a result that occurs when the option is exercised, and wherein the neurosynaptic processing logic provides said result to the one or more information repositories.

9. The cognitive computing systems of claim 1, wherein the system engages in a conversation with a user of the system regarding said option.

10. The cognitive computing systems of claim 1, wherein the system is implemented in the context of an oil and gas industry application.

11. A cognitive computer for facilitating workflow completion in the oil and gas industry, comprising:
a plurality of neurosynaptic cores operating in parallel, each neurosynaptic core coupled to at least one other neurosynaptic core and comprising multiple electronic neurons, electronic dendrites and electronic axons, at least some of said electronic dendrites and electronic axons coupling to each other in a synapse array; and
a network interface coupled to at least one of the plurality of neurosynaptic cores, the network interface provides access to one or more information repositories,
wherein the plurality of neurosynaptic cores accesses the one or more information repositories via the network interface to identify multiple solutions to a workflow enhancement request, determines a ranking of the multiple solutions, and presents the ranking to a user of the cognitive computer.

12. The cognitive computer of claim 11, wherein the synapse array stores information pertaining to the multiple solutions.

13. The cognitive computer of claim 11, wherein the plurality of neurosynaptic cores generates arguments in support of and against each of said multiple solutions without human assistance.

14. The cognitive computers of claim 11, wherein the workflow enhancement request pertains to a workflow for oil and gas industry personnel.

15. A method for enhancing workflow performance in the oil and gas industry, comprising:
receiving, at a cognitive computer, an inquiry regarding a workflow;
accessing information relating to the inquiry from an information repository using the cognitive computer;
using the cognitive computer and said information to generate an option relating to the inquiry; and
presenting said option to a user of the cognitive computer.

16. The method of claim 15, further comprising storing data pertaining to said option in an electronic synapse at an intersection of an axon and a dendrite associated with an electronic neuron in said cognitive computer.

17. The method of claim 15, further comprising the cognitive computer generating an argument favoring said option.

18. The method of claim 15, further comprising the cognitive computer generating an argument against said option.

19. The method of claim 15, further comprising the cognitive computer identifying a need for additional information, requesting and receiving said additional information, and using the additional information to generate said option.

20. The methods of claim 15, further comprising providing the cognitive computer with said inquiry using an augmented reality device.
